(19) United States
(12) Patent Application Publication
(10) Pub. No.: US 2021/0319039 A1
(43) Pub. Date: Oct. 14, 2021

(54) EXTRACTION OF A NESTED HIERARCHICAL STRUCTURE FROM TEXT DATA IN AN UNSTRUCTURED VERSION OF A DOCUMENT

(71) Applicant: RSA Security LLC, Bedford, MA (US)

(72) Inventors: Gregory A. Gerber, JR., Colorado Springs, CO (US); Corey J. Carpenter, Kansas City, MO (US); Kevin D. Bowers, Melrose, MA (US)

(21) Appl. No.: 16/844,030

(22) Filed: Apr. 9, 2020

(51) Int. Cl. G06F 16/25; G06F 16/31

(52) U.S. Cl. CPC G06F 16/254; G06F 16/31

(57) ABSTRACT

An apparatus comprises a processing device configured to analyze an unstructured version of a document to read text data contained therein having a nested hierarchical structure comprising two or more levels and to obtain at least one sample item for a given one of the levels in the nested hierarchical structure. The processing device is also configured to determine a list type associated with the at least one sample item, to identify items having the determined list type in the text data as belonging to the given, and to extract portions of the text data corresponding to respective ones of the items having the determined list type. The processing device is further configured to generate a structured version of the document that associates the extracted portions of the text data with the corresponding ones of the items having the determined list type.

### FIELD

The field relates generally to information processing, and more particularly to techniques for managing unstructured data.

### BACKGROUND

In many information processing systems, data stored electronically is in an unstructured format, with documents comprising a large portion of unstructured data. Collection and analysis, however, may be limited to highly structured data, as unstructured text data requires special treatment. For example, unstructured text data may require manual screening in which a corpus of unstructured text data is reviewed and sampled by service personnel. Alternatively, the unstructured text data may require manual customization and maintenance of a large set of rules that can be used to determine correspondence with predefined themes of interest. Such processing is unduly tedious and time-consuming, particularly for large volumes of unstructured text data.

### SUMMARY

Illustrative embodiments of the present invention provide techniques for extracting a nested hierarchical structure from text data in an unstructured version of a document.

In one embodiment, an apparatus comprises at least one processing device comprising a processor coupled to a memory. The at least one processing device is configured to perform the step of analyzing an unstructured version of a document to read text data contained therein, the text data having a nested hierarchical structure comprising two or more levels. The at least one processing device is also configured to perform the step of obtaining, for a given one of the two or more levels in the nested hierarchical structure, at least one sample item. The at least one processing device is further configured to perform the steps of determining a list type associated with the at least one sample item, identifying items having the determined list type in the text data of the document as belonging to the given level in the nested hierarchical structure, extracting, from the document, portions of the text data corresponding to respective ones of the two or more items having the determined list type, and generating a structured version of the document that associates the extracted portions of the text data with the corresponding ones of the two or more items having the determined list type.

These and other illustrative embodiments include, without limitation, methods, apparatus, networks, systems and processor-readable storage media.

### BRIEF DESCRIPTION OF THE DRAWINGS

FIG. 1 is a block diagram of an information processing system for extracting a nested hierarchical structure from text data in an unstructured version of a document in an illustrative embodiment of the invention.

FIG. 2 is a flow diagram of an exemplary process for extracting a nested hierarchical structure from text data in an unstructured version of a document in an illustrative embodiment.

FIG. 3 shows an example of a regulatory document in an illustrative embodiment.

FIG. 4 shows pseudocode for implementing a document content extraction process in an illustrative embodiment.

FIG. 5 illustrates the recursive nature of parent-child relationships for items in an internal hierarchical structure of a document in an illustrative embodiment.

FIG. 6 shows an example list type hierarchy for determining specificity of list types in an illustrative embodiment.

FIG. 7 shows another example of a regulatory document in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

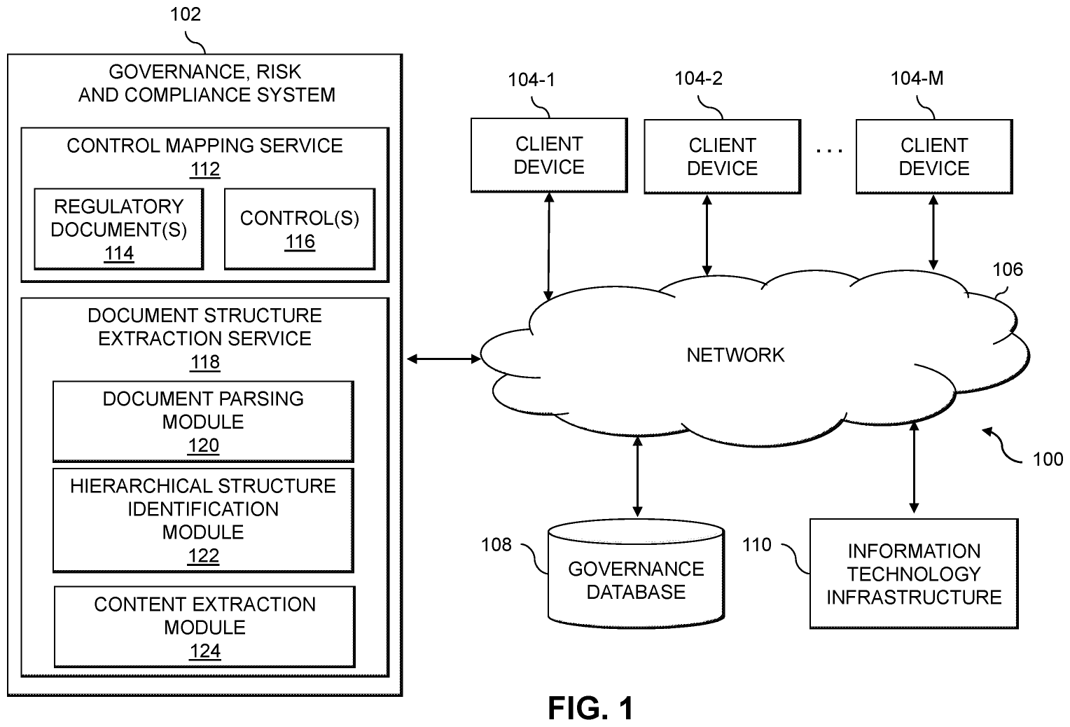

FIG. 1 shows an information processing system 100 configured in accordance with an illustrative embodiment. The information processing system 100 is assumed to be built on at least one processing platform and provides functionality for extracting a nested hierarchical structure from text data in an unstructured version of a document. The information processing system 100 includes a governance, risk and compliance (GRC) system 102 and a plurality of client devices 104-1, 104-2, . . . 104-M (collectively client devices 104). The GRC system 102 and client devices 104 are coupled to a network. Also coupled to the network 106 is a governance database 108, which may store various information relating to governance of a plurality of assets of information technology (IT) infrastructure 110 also coupled to the network 106. The assets may include, by way of example, physical and virtual computing resources in the IT infrastructure 110. Physical computing resources may include physical hardware such as servers, storage systems, networking equipment, Internet of Things (IoT) devices, other types of processing and computing devices, etc. Virtual computing resources may include virtual machines (VMs), containers, etc.

The client devices 104 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 104 may also or alternately comprise virtualized computing resources, such as VMs, containers, etc.

The client devices 104 in some embodiments comprise respective computers associated with a particular company, organization or other enterprise. In addition, at least portions of the system 100 may also be referred to herein as collectively comprising an “enterprise.” Numerous other operating scenarios involving a wide variety of different types and arrangements of processing nodes are possible, as will be appreciated by those skilled in the art.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The governance database 108, as discussed above, is configured to store and record information relating to governance of the IT infrastructure 110. Such information may include information describing a set of laws, regulations, policies, contracts, obligations or other rules that one or more enterprises operating the IT infrastructure 110 are subject to, as well as controls of the IT infrastructure 110 used to demonstrate compliance with the set of laws, regulations, policies, contracts, obligations or other rules. The set of laws, regulations, policies, contracts, obligations or other rules that a particular entity is subject to may be collectively referred to herein as “regulations.”

The governance database 108 in some embodiments is implemented using one or more storage systems or devices associated with the GRC system 102. In some embodiments, one or more of the storage systems utilized to implement the governance database 108 comprises a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the GRC system 102, as well as to support communication between the GRC system 102 and other related systems and devices not explicitly shown.

The client devices 104 are configured to access or otherwise utilize assets of the IT infrastructure 110. In some embodiments, the assets (e.g., physical and virtual computing resources) of the IT infrastructure 110 are operated by or otherwise associated with one or more companies, businesses, organizations, enterprises, or other entities. For example, in some embodiments the assets of the IT infrastructure 110 may be operated by a single entity, such as in the case of a private data center of a particular company. In other embodiments, the assets of the IT infrastructure 110 may be associated with multiple different entities, such as in the case where the assets of the IT infrastructure 110 provide a cloud computing platform or other data center where resources are shared amongst multiple different entities. As noted above, the IT infrastructure 110 is assumed to be subject to a set of regulations. The IT infrastructure 110, or an enterprise or other entity operating at least a portion of the assets thereof, may be required to demonstrate compliance with the set of regulations to users of one or more of the client devices 102. The GRC system 102 facilitates the IT infrastructure 110's compliance with the set of regulations, as well as with demonstrating such compliance.

The term “user” herein is intended to be broadly construed so as to encompass numerous arrangements of human, hardware, software or firmware entities, as well as combinations of such entities.

In the present embodiment, alerts or notifications generated by the GRC system 102 (e.g., a control mapping service 112 thereof, a document structure extraction service 118 thereof, etc.) are provided over network 106 to client devices 104, or to a system administrator, IT manager, or other authorized personnel via one or more host agents. Such host agents may be implemented via the client devices 104 or by other computing or processing devices associated with a system administrator, IT manager or other authorized personnel. Such devices can illustratively comprise mobile telephones, laptop computers, tablet computers, desktop computers, or other types of computers or processing devices configured for communication over network 106 with the GRC system 102, the control mapping service 112, and the document structure extraction service 118. For example, a given host agent may comprise a mobile telephone equipped with a mobile application configured to receive alerts or notifications from the GRC system 102 (e.g., when new regulations are detected, when compliance with one or more existing regulations has failed, etc.), from the control mapping service 112 (e.g., prompts to confirm the mapping of portions of one or more regulatory documents 114 to one or more controls 116), from the document structure extraction service 118 (e.g., prompts for examples of items in different levels of an internal hierarchical structure of the one or more regulatory documents 114, prompts for confirming the accuracy of content extracted from the one or more regulatory documents 114, etc.). The given host agent provides an interface for responding to such various alerts or notifications as described elsewhere herein.

It should be noted that a “host agent” as this term is generally used herein may comprise an automated entity, such as a software entity running on a processing device. Accordingly, a host agent need not be a human entity.

As shown in FIG. 1, the GRC system 102 comprises the control mapping service 112 and the document structure extraction service 118.

The control mapping service 112 is configured to identify regulations that apply to the IT infrastructure 110 from one or more regulatory documents 114, and to map regulations in the one or more regulatory documents 114 to a set of one or more controls 116. To do so, requirements are identified and extracted from the regulatory documents 114 and mapped to the internal controls 116 applied to assets of the IT infrastructure 110, such that an operator of the IT infrastructure 110 can easily demonstrate (e.g., to users of the client devices 104) that it complies with those requirements. The GRC system 102 may provide solutions for Regulatory & Corporate Compliance Management (RCCM) for managing the ever-changing laws and regulations that an entity which operates at least a subset of the assets of the IT infrastructure 110 must comply with. The entity must also document the controls 116 put into place, where the controls 116 may be implemented as documents that describe how the entity meets the requirements set forth by the regulatory documents 114. The regulatory documents 114, also referred to herein as “authoritative sources.” To maintain compliance, the controls 116 may need to be continually updated to adapt to changing and new regulations in the regulatory documents 114.

A given authoritative source (e.g., a given one of the regulatory documents 114) may comprise a document with an internal hierarchical structure (e.g., with several levels, each having a unique identifier (ID) and title). Though the given authoritative source has the internal hierarchical structure contained therein, the given authoritative source may be stored in electronic form as an unstructured document. The unstructured document is assumed to comprise text data that has some internal hierarchical structure that is not defined in the electronic form of the document, and thus the text data appears, from a computing perspective, to be unstructured text data. The document structure extraction service 118, as will be described in further detail below, enables efficient extraction of the internal hierarchical structure from authoritative sources such as the regulatory documents 114 to create or output structured data that is utilized by the control mapping service 112 to map to the controls 116 (e.g., documents that contain statements with instructions for complying with regulations) utilized by one or more entities operating assets of the IT infrastructure 110. The regulatory documents 114 and controls 116 may both include or otherwise utilize tags (e.g., terms that are used to generally describe subjects).

The control mapping service 112, in some embodiments, implements a recommender system for mapping between the regulatory documents 114 and the controls 116. The control mapping service 112 is configured to obtain a current set of authoritative sources providing the regulatory documents 114, a current set of controls 116, and the current mappings between them from the governance database 108. The control mapping service 112 is configured to receive one or more new regulatory documents 114 (e.g., from one or more of the client devices 104) and generates recommendations for how to map such new regulatory documents 114 to existing or new ones of the controls 116.

In some embodiments, one or more of the client devices 104 upload new regulatory documents 114 to the control mapping service 112 (or to the governance database 108, where the control mapping service 112 periodically checks the governance database 108 for new regulatory documents 114 to be mapped), performs analytics to calculate the probability that respective ones of the new regulatory documents 114 should be mapped into each of the controls 116, and then generates a set of mapping recommendations. In some embodiments, the mapping recommendations may be provided to one or more of the client devices 104, to allow one or more users thereof to approve, reject or edit the mapping recommendations before they are implemented. In other embodiments, however, the mapping recommendations may be implemented automatically (e.g., without first providing the recommendations to one or more of the client devices 104).

The control mapping service 112 may be trained based on the existing set of regulatory documents 114, controls 116 and mappings before generating the recommendations for new mappings for one or more new regulatory documents 114. For example, each document level in the internal hierarchical structure in the existing set of regulatory documents 114 may be transformed into a vector that best represents its content. To do so, term frequency-inverse document frequency (TF-IDF) techniques may be utilized, which create a vector where each element in the vector represents a word and the value of each element is the TF-IDF value calculated based on the corpus of existing regulatory documents 114. Various other techniques may be used for creating the vector, such as text vectorization using neural network auto-encoders, word embedding, etc. Similar vectorization methods are performed for the text of the existing set of controls 116.

The vector representations of the existing regulatory documents 114 and controls 116 are used to train a multi-label classifier. The multi-label classifier is used to enable prediction of tags for new regulatory documents 114. The multi-label classifier uses the existing tags that the current or existing set of regulatory documents 114 and controls 116 have as a target variable. The multi-label classifier may utilize various algorithms, such as a binary relevance algorithm with random forest as the base classifier, or any other available multi-label classifier. Using the existing mappings between the regulatory documents 114 and the controls 116, a training set and a validation set of mappings are constructed, where the validation set is being considered as new regulatory documents 114. With this, the processing described in the following paragraphs may be performed to extract features for each of the controls 116 in the training set that are considered to be mapped to the regulatory documents 114 that are in the validation set. Because the fact that whether a mapping exists or not in the validation set is known, the multi-label classifier may be trained to predict the probability of whether a mapping exists based on the provided features.

Given a new regulatory document 114 to be mapped to controls 116, the control mappings service 112 may perform the following processing. First the internal hierarchical structure of the new regulatory document 114 is extracted utilizing the document structure extraction service 118. Each level in the internal hierarchical structure of the new regulatory document 114 is converted into its vector representation based on the different level vectorizers constructed during training. A similarity score between each level in the internal hierarchical structure of the new regulatory documents 114 and each of the existing regulatory documents 114 is then calculated. In some embodiments, the similarity score may be calculated using a cosine similarity between the vector representation of the new regulatory document 114 and respective ones of the existing regulatory documents 114. The final similarity score may be derived from the different similarity scores for each level in the internal hierarchical structure of the new regulatory document 114. In some embodiments, this includes taking the similarity between the lowest levels available in the regulatory documents 114, averaging the similarities, taking the maximum, etc.

For all existing regulatory documents 114 whose similarity to the new regulatory document 114 is above a certain threshold, the existing controls 116 that were mapped to such existing regulatory documents 114 are selected as candidates for being recommended for mapping to the new regulatory document 114. In some embodiments, the lowest level of the new regulatory document 114 is vectorized using the controls 116 vector constructed during training. A similarity score between this lowest level and the existing controls 116 representation is calculated as described above. All controls 116 whose similarity is above a certain threshold are also taken as candidates to be recommended for mapping to the new regulatory document 114. Tag probabilities for the new regulatory document 114 are predicted using the multi-label classifier trained as described above. A similarity between the predicted tags and the existing tags assigned to each control 116 is then calculated, such as using cosine similarity as described above.

For each of the control 116 candidates, a set of features is extracted. The features may include, but are not limited to: the various similarities of the regulatory documents 114 from which it was derived; the final similarity of the regulatory documents 114 from which it was derived; the rank (e.g., based on similarity) of the regulatory document 114 from which it was derived compared to other similar ones of the regulatory documents 114; the similarity to the new regulatory document 114; the rank (e.g., based on similarity) compared to other controls 116; the number of regulatory documents 114 it was derived from; the similarity between the tags; the total number of regulatory documents 114 that the control 116 has been mapped to; the total length (e.g., in words) of the control 116; etc. The extracted features for each control 116 are fed into the trained multi-label classifier, where the trained multi-label classifier predicts how likely each candidate control 116 is to be mapped to the new regulatory document 114 (e.g., a score between 0 and 1). If this score is above a specific threshold, the mapping is recommended.

The recommendations for mapping the new regulatory document 114 to one or more controls 116 may be provided to a user (e.g., of one or more of the client devices 104), where the user may accept, reject, or edit and then accept the recommendations. The user selections (e.g., accepting, rejecting, or editing) may be used for further training and adjustment of the multi-label classifier for providing even more accurate recommendations. In addition, new regulatory documents 114 for which no mapping was found may be grouped together and delivered to the user as a set of regulatory documents that should be mapped to one or more new controls that do not exist in the current set of controls 116.

The control mapping service 112, as described above, may rely on knowing the internal hierarchical structure of the regulatory documents 114. The document structure extraction service 118 is configured to extract the internal hierarchical structure from regulatory documents 114 that are in an unstructured format (e.g., which contain unstructured or loosely-structured text data). A human may be able to identify the structure of a regulatory document and recognize where requirements exist therein. The process of manually reviewing regulatory documents, however, is tedious, time-consuming, and can be error prone (e.g., particularly with lengthy regulatory documents containing large amounts of unstructured text data). The document structure extraction service 118 advantageously automates the extraction of internal hierarchical structure from documents stored in unstructured formats (e.g., new regulatory documents 114 that are to be mapped to the controls 116 by control mapping service 112). To do so, the document structure extraction service 118 utilizes a document parsing module 120, a hierarchical structure identification module 122, and a content extraction module 124.

The document parsing module 120 is configured to analyze an unstructured version of a document to read text data contained therein, the text data having a nested hierarchical structure comprising two or more levels. The hierarchical structure identification module 122 is configured to obtain, for a given one of the two or more levels in the nested hierarchical structure, at least one sample item, and to determine a list type associated with the at least one sample item. The hierarchical structure identification module 122 is further configured to identify items having the determined list type in the text data of the document as belonging to the given level in the nested hierarchical structure. The content extraction module 124 is configured to extract, from the document, portions of the text data corresponding to respective ones of the two or more items having the determined list type. The content extraction module 124 is further configured to generate a structured version of the document that associates the extracted portions of the text data with the corresponding ones of the two or more items having the determined list type. The structure version of the document may be provided to the control mapping service 112 for use in mapping requirements contained therein to the controls 116.

Although shown as elements of the GRC system 102 in the FIG. 1 embodiment, one or both of the control mapping service 112 and the document structure extraction service 118 in other embodiments can be implemented at least in part externally to the GRC system 102, for example, as a stand-alone server, set of servers or other type of system coupled to the network 106. In some embodiments, one or both of the control mapping service 112 and the document structure extraction service 118 may be implemented at least in part within one or more of the client devices 104.

The control mapping service 112 and the document structure extraction service 118 in the FIG. 1 embodiment are assumed to be implemented using at least one processing device. Each such processing device generally comprises at least one processor and an associated memory, and implements one or more functional modules for controlling certain features of the control mapping service 112 and the document structure extraction service 118 (e.g., the document parsing module 120, the hierarchical structure identification module 122, and the content extraction module 124).

It is to be appreciated that the particular arrangement of the GRC system 102, the control mapping service 112, and the document structure extraction service 118 illustrated in the FIG. 1 embodiment is presented by way of example only, and alternative arrangements can be used in other embodiments. As discussed above, for example, the GRC system 102, or one or more portions thereof such as the control mapping service 112 or document structure extraction service 118, may in some embodiments be implemented internal to one or more of the client devices 104. As another example, the functionality associated with the document parsing module 120, the hierarchical structure identification module 122, and the content extraction module 124 may be combined into one module, or separated across more than three modules with the multiple modules possibly being implemented with multiple distinct processors or processing devices.

At least portions of the control mapping service 112 and document structure extraction service 118 (e.g., the document parsing module 120, the hierarchical structure identification module 122, and the content extraction module 124) may be implemented at least in part in the form of software that is stored in memory and executed by a processor.

It is to be understood that the particular set of elements shown in FIG. 1 for extracting a nested hierarchical structure from text data in an unstructured version of a document is presented by way of illustrative example only, and in other embodiments additional or alternative elements may be used. Thus, another embodiment may include additional or alternative systems, devices and other network entities, as well as different arrangements of modules and other components.

By way of example, in other embodiments, the control mapping service 112 and the document structure extraction service 118 may be implemented external to the GRC system 102, such that the GRC system 102 can be eliminated.

It should also be appreciated that the functionality of the document structure extraction service 118 is not limited solely for use in extracting the structure of regulatory documents 114 to facilitate mapping to controls 116. The functionality of the document structure extraction service 118 may be utilized in various other contexts, such as in the transformation or conversion of unstructured version of a document to a structured version of the document (e.g., by extracting the internal hierarchical structure from unstructured text data therein). This may be useful in various applications, such as analyzing log or event data. Thus, in some embodiments, the document structure extraction service 118 may be part of or otherwise associated with a system other than the GRC system 102, such as, for example, a security operations center (SOC), a critical incident response center (CIRC), a security analytics system, a security information and event management (SIEM) system, etc.

The control mapping service 114 and the document structure extraction service 118, and other portions of the system 100, in some embodiments, may be part of cloud infrastructure as will be described in further detail below. The cloud infrastructure hosting one or both of the control mapping service 112 and the document structure extraction service 118 may also host any combination of the GRC system 102, one or more of the client devices 104, the governance database 108 and the IT infrastructure 110.

The control mapping service 112 and the document structure extraction service 118, and other components of the information processing system 100 in the FIG. 1 embodiment, are assumed to be implemented using at least one processing platform comprising one or more processing devices each having a processor coupled to a memory. Such processing devices can illustratively include particular arrangements of compute, storage and network resources.

The client devices 104 and GRC system 102 or components thereof (e.g., the control mapping service 112 and the document structure extraction service 118) may be implemented on respective distinct processing platforms, although numerous other arrangements are possible. For example, in some embodiments at least portions of one or both of the control mapping service 112 and the document structure extraction service 118 and one or more of the client devices 104 are implemented on the same processing platform. A given client device (e.g., 104-1) can therefore be implemented at least in part within at least one processing platform that implements at least a portion of one or both of the control mapping service 112 and the document structure extraction service 118.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the client devices 104, the GRC system 102 or portions or components thereof (e.g., the control mapping service 112 and the document structure extraction service 118), to reside in different data centers. Numerous other distributed implementations are possible. One or both of the control mapping service 112 and the document structure extraction service 118 can also be implemented in a distributed manner across multiple data centers.

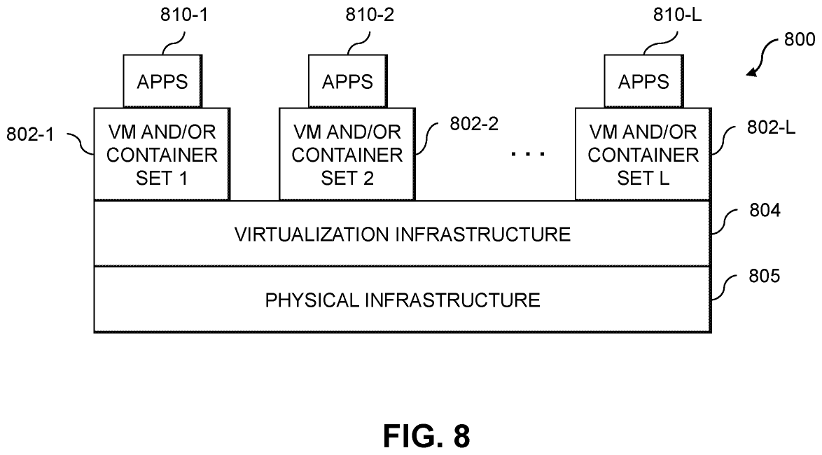

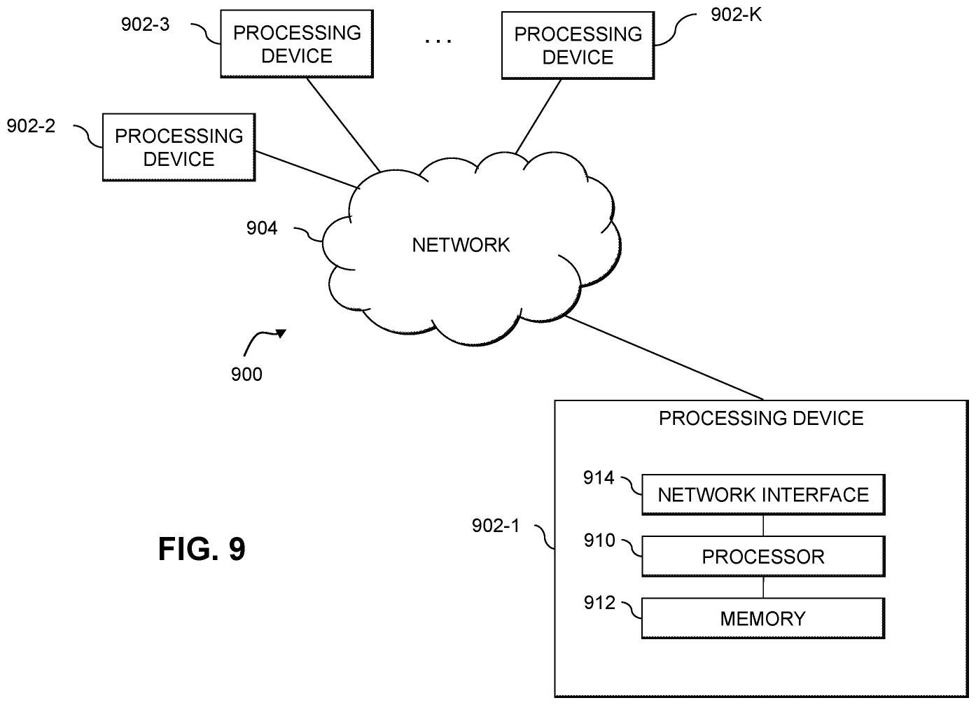

Additional examples of processing platforms utilized to implement one or both of the control mapping service 112 and the document structure extraction service 118 in illustrative embodiments will be described in more detail below in conjunction with FIGS. 8 and 9.

It is to be appreciated that these and other features of illustrative embodiments are presented by way of example only, and should not be construed as limiting in any way.

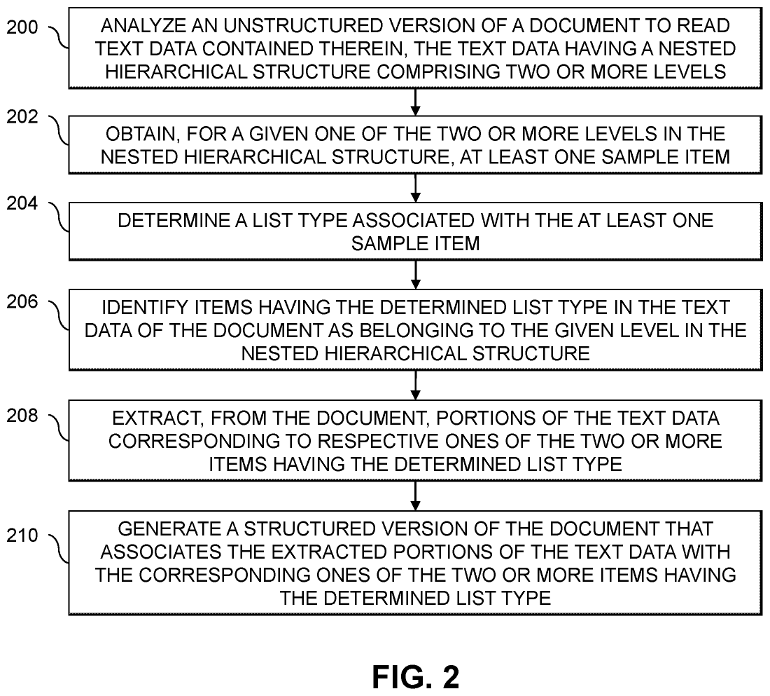

An exemplary process for extracting a nested hierarchical structure from text data in an unstructured version of a document will now be described in more detail with reference to the flow diagram of FIG. 2. It is to be understood that this particular process is only an example, and that additional or alternative processes for extracting a nested hierarchical structure from text data in an unstructured version of a document can be carried out in other embodiments.

In this embodiment, the process includes steps 200 through 210. These steps are assumed to be performed by the document structure extraction service 118 utilizing the document parsing module 120, the hierarchical structure identification module 122, and the content extraction module 124. The process begins with step 200, analyzing an unstructured version of a document to read text data contained therein, the text data having a nested hierarchical structure comprising two or more levels. The document may comprise a text file, and step 200 may comprise reading the text data from the text file. The document may alternatively comprise a HyperText Markup Language (HTML) file, and step 200 may comprise fetching an HTML page and traversing content of the HTML page to read the text data. The document may alternatively comprise a Portable Document Format (PDF) file, and step 200 may comprise converting the PDF file to one of a text file and a semi-structured representation comprising formatting details of the PDF file. Step 200, in some embodiments, may comprise extracting document context for the document, the document context comprising at least one of a document title, a document description, a document version, a document author, a document type, a link to the document, and a disclaimer associated with the document.

In step 202, at least one sample item is obtained for a given one of the two or more levels in the nested hierarchical structure, at least one sample item. The at least one sample item, in some embodiments, is obtained from a document hierarchy template associated with the document. In other embodiments, the at least one sample item may be obtained from a user.

A list type associated with the at least one sample item is determined in step 204. Step 204, in some embodiments, includes analyzing a syntax of the at least one sample item to infer the determined list type. Step 204, in other embodiments, may further or alternatively include matching the at least one sample item with a set of known list types. When the at least one sample item matches two or more of the set of known list types, step 204 may include selecting a most specific one of the matched two or more known list types. The set of known list types may be arranged in a list type hierarchy from least specific to most specific, and wherein selecting the most specific one of the matched two or more known list types may comprise traversing the list type hierarchy until the most specific one of the matched two or more known list types is reached. When the at least one sample item does not exactly match a syntax of any of the set of known list types, step 204 may include selecting from the set of known list types a longest matching one of the known list types that matches a portion of text of the at least one sample item, or performing approximate matching of text of the at least one sample item with at least one of the known list types in the set of known list types.

Items having the determined list type in the text data of the document are identified as belonging to the given level in the nested hierarchical structure in step 206. In some embodiments, the at least one sample item comprises a first sample item with a first syntax and a second sample item with a second syntax different than the first syntax, step 204 includes determining the list type associated with the at least one sample item comprises determining a first list type associated with the first sample item and a second list type associated with the second sample item, and step 206 includes identifying one or more items having the first list type and identifying one or more items having the second list type.

Portions of the text data corresponding to respective ones of the two or more items having the determined list type are extracted from the document in step 208. In some embodiments, one or more of the steps 202 through 208 may be performed at least in part based on user input. For example, a user may provide the at least one sample item in response to system prompts in step 202. The user may also be prompted to confirm the determined list type in step 204, to confirm the identified items in step 206, and to confirm the extracted portions of the text data in step 208.

In some embodiments, an iteration of steps 202 through 208 is performed for each of the two or more levels in the nested hierarchical structure, and step 206 in each iteration may include identifying one or more parent-child relationships for items in the given level of the nested hierarchical structure of the text data with one or more other items in one or more other ones of the two or more levels in the nested hierarchical structure. A first one of the iterations of steps 202 through 208 may be performed for a topmost one of the two or more levels in the nested hierarchical structure, and subsequent ones of the iterations of steps 202 through 208 may be performed for lower ones of the two or more levels in the nested hierarchical structure.

The FIG. 2 process continues with step 210, generating a structured version of the document that associates the extracted portions of the text data with the corresponding ones of the two or more items having the determined list type. In some embodiments, the document comprises a regulatory document specifying one or more requirements for operation of assets in an IT infrastructure, and the FIG. 2 process further includes utilizing the structured version of the document to map the specified one or more requirements to controls for operating the assets in the IT infrastructure.

In some embodiments, the structured version of the document comprises a structured file format such as an Extensible Markup Language (XML) format, a JavaScript Object Notation (JSON) format, a Comma Separate Value (CSV) format, etc. When the structured version comprises an XML, JSON or similar structured file format, the structured file format may comprise a list of the identified items, where each item has an associated key with a unique identifier of that item and a key specifying parent-child relationships of that item with one or more other items in one or more other ones of the two or more levels in the nested hierarchical structure. When the structure version utilizes CSV, there may be a CSV file generated for each of the two or more levels in the nested hierarchical structure. A given one of the CSV files for the given level of the nested hierarchical structure may comprise at least one column specifying parent-child relationships of a given one of the identified items with one or more other items in one or more other ones of the two or more levels in the nested hierarchical structure.

As described above, in various information processing systems a large quantity of data is stored electronically in an unstructured format, with documents comprising a large portion of the unstructured data. Important information is oftentimes stored in documents, but unstructured data can be difficult to work with. This leaves two options—underutilizing this important information, or extracting this important information into a more usable format. While certain documents themselves are unstructured, the documents may contain some sort of an internal hierarchical structure. Converting such documents to a structured data format ensures that the documents are easier to work with.

Documents are constructed by humans, which means that a generic document has no guaranteed format. There are multiple generic templates for how documents might be structured, but deviations can and do occur from these templates. This flexibility in document structure is necessary to enable the expression of creativity and style, but this complicates the conversion of unstructured documents to structured data.

In certain contexts, the extraction of document structure is a requirement. Without an effective solution to perform this conversion programmatically, significant manual effort is required. For example, in a regulatory compliance management context, an entity such as a company is subjected to a variety of compliance requirements, including but not limited to external regulations and standards, internal policies, customer contractual commitments, etc. Failure to comply with all the compliance requirements could lead to corrective actions, fines, and even contractual issues with existing customers. As a result, companies must spend countless hours to identify and understand these documents and how they apply to their organization.

Many of the tasks associated with the management of regulatory changes require substantial manual effort. One of these tasks is the extraction of requirements from regulatory documents. In order to accomplish this, compliance analysts must find all potentially relevant documents, read through each of the documents to understand them, and then manually extract all requirements from the documents.

Illustrative embodiments provide techniques for automatically or programmatically extracting internal hierarchical structure from documents (e.g., utilizing the document structure extraction service 118), reducing the amount of time and manual effort a user must spend. In some embodiments, the document structure extraction service 118 identifies the internal hierarchical structure of a document by asking one or more users (e.g., of one or more of the client devices 104) to provide examples of items at each of the levels of the document hierarchy. After verifying that the structure is what the users expect, the document is outputted in a structured format that is readily available for consumption.

As noted above, the contents of various documents may be quite valuable to a company. Conversion to a structured data format enables users to more easily work with the content of the documents. The techniques described herein may be utilized in a wide variety of application areas, including but not limited to governance, risk and compliance or GRC.

The current regulatory landscape is complex. Companies, for example, may be required to demonstrate that they comply with many requirements in applicable regulations and industry standards. The scope of these regulations depends on the nature of their business as well as the jurisdictions in which they conduct business. From a geographic standpoint, a company must comply with federal, state, and local regulations everywhere they operate. As a company expands into new geographies, the volume of applicable regulations will grow dramatically, and it compounds as a company expands into international markets. A company may also often look at new markets or new products that could open them up to other sets of regulations—such as doing business with a government body or taking in personal or healthcare information in a new product line.

This volume of applicable regulations makes it challenging to set up and maintain compliance programs for all of the applicable requirements. This problem becomes increasingly more difficult as those companies must identify and understand regulatory requirements from newly added or modified regulations. Each of these regulations has a lifecycle of its own as the governing bodies are modifying and updating them on a continuous basis to keep up with the changing landscape of different administrations as well as technological advances. In fact, the United States Code of Federal Regulations alone is over 185,000 pages, containing more than 100 million words. From 2013 to 2018, the Code of Federal Regulations saw an increase of 9,938 pages—an increase of more than 5%. The quantity and velocity of regulatory changes, in addition to the staggering volume of existing regulatory requirements, leaves all but the most prepared companies feeling overwhelmed.

As a company identifies an applicable regulation, it often manually identifies and extracts requirements from this regulation. These requirements must then be mapped to the company's internal controls, so that the company can easily demonstrate that it complies with that requirement. Software (e.g., the control mapping service 112 of GRC system 102 described above) may be used to map new requirements (e.g., in regulatory documents 114) to existing control standards (e.g., controls 116) and to aid in managing a compliance program once the content has been mapped. Such software reduces time and effort spent, but gaps still exist. For example, some companies manually extract requirements from new regulations (e.g., via copying from the source documentation and directly pasting it into the compliance management software or a format that can be imported into the compliance management software).

On the other hand, machines are well-equipped to ease this burden. If the proper structure of the document can be identified, then a machine could easily partition and export the content into a user-friendly format.

The challenge is that the structure of regulatory documents is not standardized, which complicates the automation of requirement extraction from a regulatory document. Additionally, the structure in the document could be incomplete or could contain mistakes. This requires the solution to be flexible to accommodate inconsistencies within a document. These requirements necessitate the involvement of the user in determining the proper document structure.

Embodiments provide techniques for reducing the amount of time and effort required to extract structure from a document. Such techniques, in some embodiments, take examples from a user of different components of the document. Such example components are used to predict how the document should be decomposed to obtain its internal hierarchical structure. The components of the document are outputted, while maintaining the internal hierarchical structure of the document. Some techniques for extracting document structure rely on statistical methods, or are intended to capture the document structure of paragraphs rather than the outline. Such techniques, however, lack the flexibility required to accommodate document inconsistencies or differences in human judgment on how to extract requirements from regulatory documents.

Today, most companies, enterprise, organizations or other entities rely on manual efforts to read and parse regulatory documents. These regulatory documents often are very large, but have a structure that repeats throughout it. When done manually, this task of parsing the regulatory documents requires a significant amount of time and resources, and it tends to be error prone. It is also a low value task for a valuable and expensive resource to perform, so lower cost resources are used who are less experienced and more likely to make mistakes.

A solution that guides the user through this process would reduce time spent on this task, and it could reduce the number of errors, allowing high value resources to do it quickly or low value resources to do it more accurately. Many errors result from user fatigue while performing such a tedious task on a dense, voluminous document. As a result, the impact of this solution would be felt by any customer using regulatory compliance management software, especially if that software requires that regulatory requirements are in a structured format.

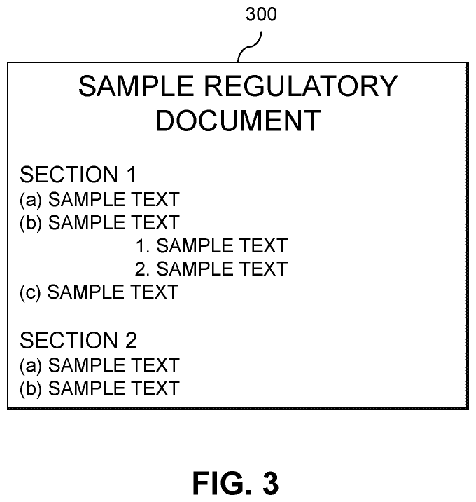

The purpose of some embodiments is to identify the internal hierarchical structure of a given document with an unstructured format, and to convert the content of the given document into a structured data format. In order to accomplish this, some embodiments extract the content from the given document into partitions while maintaining parent-child relationships. Consider, as an example, the document 300 shown in FIG. 3. To begin, the top or first level of the internal hierarchical structure of the document 300 is identified as being of the form SECTION n, where n∈ [symbol] ⁺. In other words, the top level starts with the capitalized word “SECTION” and is followed by a space and a positive integer. The next or second level of the internal hierarchical structure of the document 300 is identified as being of the form (α), where α=[a−z]+. In other words, the second level starts with an open parenthesis, which is followed by one or more lowercase alphabet letters, which is followed by a closed parenthesis. The next or third level of the internal hierarchical structure of the document 300, which in this example is the lowest level, is identified as n, where n∈ [symbol] ⁺. In other words, the lowest level starts with a positive integer followed by a period. It should be appreciated that the levels shown in the document 300 of FIG. 3 are presented by way of example only, and that embodiments are not limited to use with the specific level identifiers (e.g., SECTION n, (α), n.). Various other types of level identifiers may be used, such as the use of uppercase or lowercase Roman numerals (e.g., I, II, III, etc., i, ii, iii, etc.), the use of uppercase or lowercase letters (e.g., A, B, C, etc.) with or without parenthesis, the user of numbers, etc. In addition, documents are not limited to having three hierarchical levels. In other embodiments, a given document may have more or fewer than three hierarchical levels.

Once the levels of the document 300 are identified, the correct subtext for each item is selected and this content is exported (e.g., provided to a user of one of the client devices 104, to a compliance management tool such as control mapping service 112, etc.). In the description below, it is assumed that the content will be consumed by a compliance management tool, such as the RCCM solution of a GRC system 102. Therefore, the exported content should be formatted so that the compliance management tool import process is convenient for the user. Some examples of possible export formats are CSV, XML, JSON, etc.

The process of determining the internal hierarchical structure of a given document may be viewed as containing four parts or phases: (1) reading the document; (2) extracting document context; (3) extracting content for each level; and (4) exporting results. The first step is to convert the given document into a more convenient format. Once the given document is ready, its content is extracted. In order to accomplish this second step, a user (e.g., of one of the client devices 104) is asked to provide high-level details about the given document. Once these details are provided, the document structure can be identified.

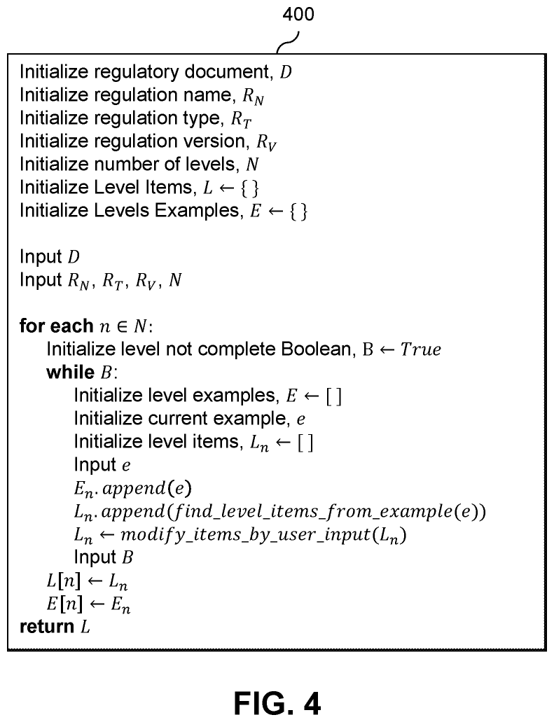

Document content extraction is performed level-by-level, starting with the first or top level. Once the correct items have been extracted for the first level, the solution moves to the second level. This process continues until all items from all levels have been properly extracted. The items from all the levels are then used to extract the specific content from the document while maintaining the proper parent-child relationships. This process is depicted in the pseudocode 400 of FIG. 4.

In some embodiments, it is assumed that an electronic copy of the regulatory document is available. The document text is used as an input in this solution. Depending on the format of the regulatory document (e.g., HTML, PDF, Word Document, etc.), the solution may consider text attributes in addition to the content of the text. For example, if a regulatory document is provided in HTML form, header tags, bold text tags and other types of tags may be leveraged to identify items in the text. Some embodiments further assume that the regulatory document has clearly identifiable markers for structure. Without these markers, neither the solutions described herein nor a human would have a way to identify structure in the regulatory document.

As noted above, the first part or phase of the solution includes reading the given document. Before content can be extracted from the given document, the given document should be in a convenient format. Specifically, the solution should know what part of the text the user is referring to when they select an example. How this phase is accomplished depends on the format that the given document is provided in. For example, if the given document is a text file, then only the content of the given document needs to be read. If the given document is in HTML, then the solution fetches the HTML page and traverse the HTML content properly as the subsequent phases of the solution are carried out. If the given document is a PDF file, then the PDF file is converted to text or a semi-structured representation such as HTML, JSON, XML, etc. If possible, details on the formatting of the PDF document should be included.

The second part or phase of the solution includes document context extraction. Once the text of the given document is ready for extraction, a user (e.g., of one of the client devices 104) will be prompted to provide details about the given document. Some of these details could potentially be extracted when reading the given document in the first phase described above. For example, the user might be asked to provide a title of the given document. This title could potentially be extracted while the solution reads the given document in the first phase. The extracted title would be presented to the user, enabling the user to either confirm or change the document title. Additional examples of document context details include the document description, document version, author, document type (e.g., law, regulation, industry standard, etc.), link to the document, and a disclaimer.

The third part or phase of the solution is document level extraction. As noted above, it is assumed that the given document is divided into several hierarchical levels (e.g., three hierarchical levels as in document 300 of FIG. 3). These levels are assumed to be nested, meaning that they have parent-child relationships. The concept of parent-child relationships can be generalized to ancestor-descendant relationships, where an item is a descendant of an ancestor so long as a continuous line of descendants can be traced from the ancestor to the descendant. To maintain the integrity of the document structure, all ancestor-descendant relationships should be accounted for.

For example, the k^{th} item in the second level, I_{2,k}, would be the child of the item in the first level that most recently precedes it, I_{1,j}. While a third level item, I_{3,l}, occurring after I_{2,k} but before either I_{1,j+1} or I_{2,k+1} would be the child of I_{2,k} and I_{1,j}. More specifically, item [symbol] is a descendant of item k so long as: k exists in a higher level than [symbol] ; k precedes [symbol] ; and no item from any level higher than or equal to the level in which k exists is found between items k and [symbol] . Children (e.g., direct descendants) can be identified by strengthening the first axiom. Item [symbol] is a child of item k so long as: k exists in the level that is exactly one level higher than [symbol] ; k precedes [symbol] ; and no item from any level higher than or equal to the level in which k exists is found between items k and [symbol] .

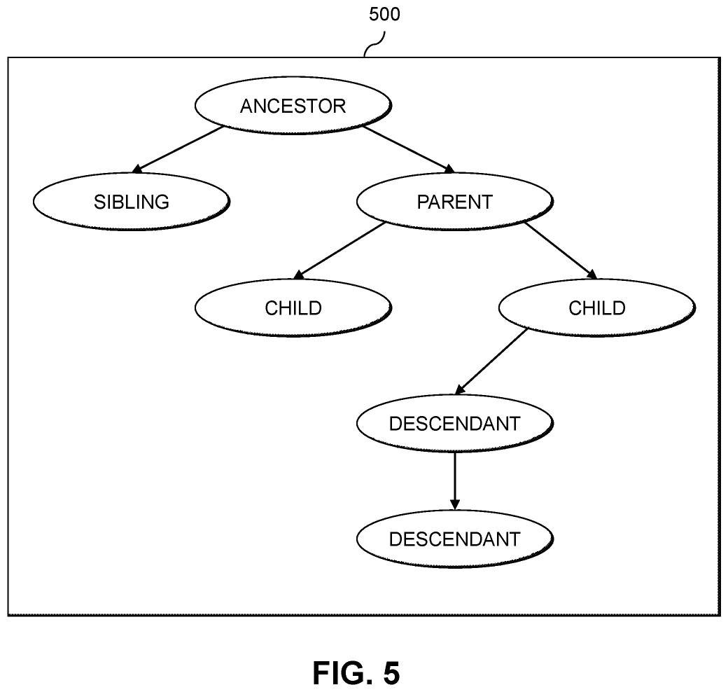

The solution should capture all parent-child relationships. So long as the parent-child relationships are properly identified, all ancestor-descendant relationships will be identified. This is due to the recursive nature of the parent-child relationships as shown in structure 500 of FIG. 5. It should be noted that terms such as “parent” and “child” are relative. The topmost ancestor node is the parent of the parent node and the sibling node. This solution runs top-down. This means that the ancestors will be filled out before the descendants. The parent-child relationships between the ancestor node and the sibling and parent nodes will be identified before the child nodes are mapped to the parent node.

In some embodiments, it is assumed that the user provides examples for each level of the given document. The solution begins with the top level, I₁. The user is asked to provide one or more examples of items at the top level, one at a time. As each example is received, the solution extracts the content for each item i in I₁, I_{1,i}. Once this has been completed, the solution moves to the next level, I₂, and the above processing is repeated until all levels have been extracted.

Suppose that the solution is currently on level Iₖ. The solution prompts the user to provide an example of an item at level Iₖ. To find other items in Iₖ that are like the example provided, the solution infers what is meant by the example. For instance, suppose that level Iₖ is of the form (α), where α=[a−z]+. Further, suppose that (a) is provided as an example. The solution would then identify that (b), (c), (d), etc. are also items in Iₖ. To make this inference, the solution references a set of known list or item types. If the example matches a known list type, then the solution assumes that the example is of that list type. If more than one list type is matched, the most specific list type is selected as a match for the example. If a unique, most specific list type cannot be determined, then a set of list types under consideration may be provided to the user and the user is prompted to select one of the list types, to provide additional examples, etc.

For example, suppose that the user provides (a) as an example. Suppose that the set of known list types include {α, α., α), (α), (α)., [α]|α=[a−z]+}. The solution compares the example to the known list types to determine which list types could identify this example. The first, third, and fourth list types {α, α), (α)} all match the example as they are all substrings of (a). The fourth list type, (α), is the most specific list type, and so it would be the list type selected. Additionally, it exactly matches the example the user provided.

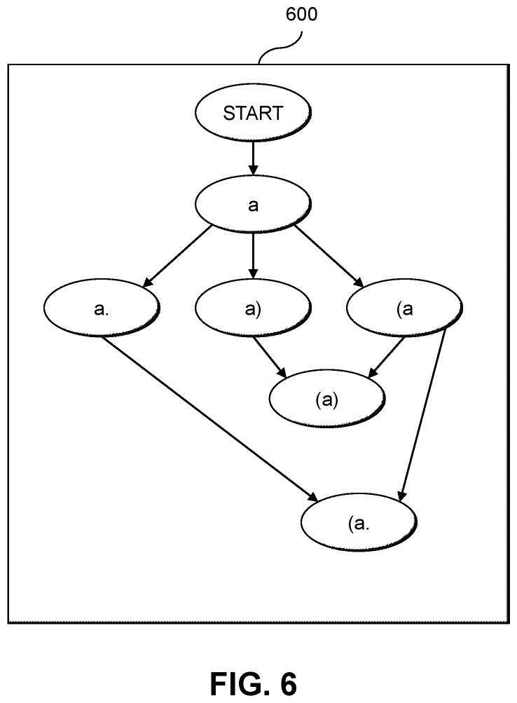

In order to automatically identify whether list type k is considered more specific than list type j, the solution must identify a hierarchy of list types. An example list type hierarchy 600 is shown in FIG. 6. In some embodiments, the list type hierarchy is based on the length of the list types (e.g., where a more specific list type tends to be longer than a less specific list type). For example, (a) is more specific than a), which is more specific than a.

There are two error cases that should be considered. Suppose that a user provides too much text. For instance, suppose the user provides the example “(a) Lorem ipsum dolor.” It is clear that the user provided too much text for the example. Rather than searching for all cases of (α) with Lorem ipsum dolor appended to it, this solution would search for (b), (c), etc. This is because (α) is the longest substring list type matching this example.

On the other hand, suppose the user provided “(a)” as an example, but “(α).” is the list type the user intended. In other words, the list items the user intends to match are (a)., (b)., (c)., etc. In this case, the user did not include the trailing period. The solution would not find the correct list, and it would ask the user to provide another example. Although this is a minor inconvenience, some embodiments chose substrings for list type examples due to their simplicity to implement. More complex implementations could include approximate matching in order to return the correct list in this case.

When the solution identifies the correct list type, it then extracts the items it finds that match the identified list type. Depending on the list type, ordering may be important. For example, if the list type is of the form (α), where α=[a−z]+, then items should exist in the following order: {(a), (b), . . . , (aa), (ab) . . . }. Note that there is no specified number of items that need to be found, but they should be found in the correct order. This solution maintains a knowledge base of known orderings for common list types (e.g., alphabet characters, Roman numerals, numbers, etc.).

It should be appreciated that identifiers at any level (e.g., other then the highest level) may repeat. For example, in the document 300 of FIG. 3, (a) and (b) exists twice, once after SECTION 1 and once after SECTION 2. This is due to the recursive nature of the internal hierarchical structure of documents. To account for repeated lists, some embodiments maintain the notion of a scope.

A scope is defined as the subtext in which the solution searches for items. When searching for items in level I₁, the scope is defined as the entire document. As the level number k increases, the size of the scope tends to decrease. When considering items in level Iₖ, some embodiments search in the text associated with each item in level Iₖ₋₁. Within a given scope, the items should be consistent and properly ordered. Once the items in Iₖ are identified, they may be presented to the user for validation. The user can choose to accept or reject each or all of the extracted examples. If Iₖ is incomplete, the user may provide one or more additional examples. The solution will then attempt to extract more items in Iₖ with the one or more additional examples. This process may be repeated as desired (e.g., until the user accepts level Iₖ as correct, until some designated threshold number of iterations is reached, etc.).

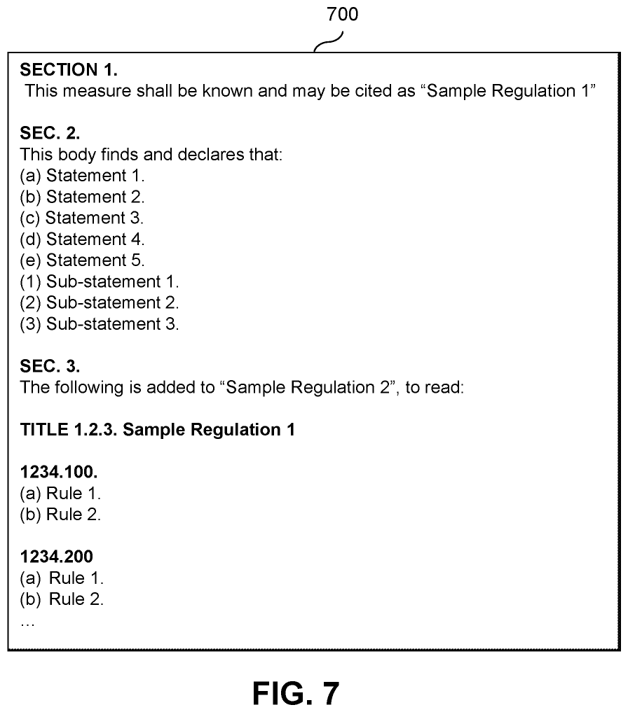

For example, consider the regulatory subtext 700 in FIG. 7. Notice that list type examples include {SECTION n., SEC. n., n. n., (α)|n∈ [symbol] +, α=[a−z]+}. Examples of the n. n. list type include 1234.100 and 1234.200. Suppose the user wanted to consider SECTION n., SEC. n., and n. n. (e.g., 1234.100 and 1234.200) as the same level. The user might provide “SEC. 2.” as a first example. The solution would return SEC. 2., SEC. 3., SEC. 4., etc. In some embodiments, the solution is set up to recognize that “SEC.” is an abbreviation of “SECTION” and thus SECTION 1. would also be returned. Assume, however, that SECTION 1. is not returned as an example in this iteration. In this case, the user would agree with the results the solution returned, but the results are incomplete for this level. The user may then provide “1234.100” as a second example, and the solution would then return 1234.100, 1234.200, etc. Now the list of identifiers for this level include {SEC. 2., SEC. 3., SEC. 4., etc.} and {1234.100, 1234.200, etc.}.

Suppose, as noted above, that the solution does not return SECTION 1. as an example (e.g., that the solution is not configured to recognize that SEC. is an abbreviation of SECTION). In this case, the user may provide “SECTION 1.” as a third example. Alternatively, the solution may be able to accommodate manual additions and deletions to the list of level identifiers. In such embodiments, the user can manually add “SECTION 1.” to the list of level identifiers. Additionally, suppose that the solution included a list identifier of “1234.100.000” by mistake. The user should be able to manually delete this entry.

Once Iₖ has been accepted by the user, the solution proceeds to level Iₖ₊₁. This process continues until all levels are complete. While on level Iₖ₊₁, the solution must properly consider the parent-child relationships between items in Iₖ and items in Iₖ₊₁. An item in Iₖ₊₁ should reference the parent item in Iₖ so long as one exists. The solution is aware of where the items in Iₖ occur, so it will be able to determine the proper parent for each item in Iₖ₊₁.

Once all the levels have been completed, the solution must identify the proper subtext for each item at each level. Given that the solution knows where each item at each level occurs in the document, it can properly assign a subtext to each item. For example, item k is assigned all text that occurs between item k and the very next item, [symbol] . It does not matter at which levels items k and [symbol] occur. Rather any text that occurs between an item k and the subsequent item (or the end of the level for the last item in a level), regardless of level, is assigned to item k.

Once the solution has properly extracted all items from all levels and their corresponding content, the data is exported in a format convenient for the user, or for a system that utilizes the structure for mapping regulations and controls (e.g., the control mapping service 112 of GRC system 102 as described above). For example, some compliance management tools accept XML or JSON formats. This data can be converted to either of these formats. Other compliance management tools may utilize CSV files to import data. Further, the data may be exported to two or more tools or systems that require data in two or more different formats. For an XML or JSON format, each item in the list will have a unique identifier that will be included as a key in the file. The parent-child relationship will also be included as a key for an item in the data. For tools that require CSV format, a separate CSV file may be used for each hierarchical level in the document structure. Each such CSV file may include at least one column for specifying the parent-child relationships. With this data requirement, all of the data for each level may be exported as a single CSV file. For example, if a given document contains four distinct levels, the solution would export four CSV files, one for each of the four levels.

In some embodiments, the above-described solution may be extended for handling internal hierarchical document formats. The solution described above identifies the internal hierarchical structure of a given document. In addition to returning the section structure of the document, the solution in some embodiments may be extended to return a table of contents or outline structure, or may be used to convert a given document into a semi-structured format such as XML or HTML.

The above-described solution may further or alternatively be extended for handling additional document types. The solution may be used to identify structure in any document that contains an internal hierarchical structure. Some non-limiting examples include policy documents, contract documents, etc. Both policies and contracts may be key sources of obligations, in addition to laws or regulations. Many companies, enterprises, organizations or other entities lack the ability to get policy documents and contract documents into compliance management software for analysis and reporting. The techniques described herein, however, are suited for handling policy and contract documents, in addition to laws, regulations or any other type of document with an internal hierarchical structure.

In some embodiments, document hierarchy templates may be used. For example, to save resources (e.g., user time, computational resources, etc.), a document hierarchy template could be saved once a document has been processed. This would enable the solution to quickly process similar documents in the future (e.g., by identifying that a subsequently handled document follows a given document hierarchy template, the user does not necessarily need to be queried for examples of list types at each level).

Item or list type inference may also be used in some embodiments. Requiring a knowledge base of known list types may, in some cases, restrict the solution's ability to accommodate a large variety of list types. A guess of the structure of an example could be created without prior knowledge of the particular item or list type. This extension may require multiple examples, so that commonalities and differences between items can be identified. This extension enables the solution to infer which components of the examples are iterators and which components are constant text. In some embodiments, the use of indentation may be used as an identifier. Some documents, for example, may indicate the particular hierarchical level with indentation. In addition to relying on identifiers, the solution may rely on leading whitespace indicators to identify the depth of indentations (and corresponding level) in a document.

Some embodiments are also configured to utilize approximate matching. It is possible that a user could exclude part of the list type in a provided example. For instance, a user may provide “(a)” as an example, where the list type is actually of the form (a)., (b)., (c)., etc. Approximate matching may be used such that the proper items are returned in such cases. The solution would visually identify which matches are approximate (e.g., via highlighting, underline, italics, bold, etc.) so that the user is made aware that the suggested matches do not exactly match the example provided.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for extracting a nested hierarchical structure from text data in an unstructured version of a document will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100 in FIG. 1. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. A hypervisor platform may be used to implement a hypervisor within the virtualization infrastructure 804, where the hypervisor platform has an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912.

The processor 910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for extracting a nested hierarchical structure from text data in an unstructured version of a document as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, document types, list types, hierarchical structures, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
analyzing an unstructured version of a document to read text data contained therein, the text data having a nested hierarchical structure comprising two or more levels;
obtaining, for a given one of the two or more levels in the nested hierarchical structure, at least one sample item;
determining a list type associated with the at least one sample item;
identifying items having the determined list type in the text data of the document as belonging to the given level in the nested hierarchical structure;
extracting, from the document, portions of the text data corresponding to respective ones of the two or more items having the determined list type; and
generating a structured version of the document that associates the extracted portions of the text data with the corresponding ones of the two or more items having the determined list type.

2. The apparatus of claim 1 wherein the document comprises one of:
a text file, wherein analyzing the unstructured version of the document comprises reading the text data from the text file;
a HyperText Markup Language (HTML) file, wherein analyzing the unstructured version of the document comprises fetching an HTML page and traversing content of the HTML page to read the text data; and
a Portable Document Format (PDF) file, wherein analyzing the unstructured version of the document comprises converting the PDF file to one of a text file and a semi-structured representation comprising formatting details of the PDF file.

3. The apparatus of claim 1 wherein analyzing the unstructured version of the document comprises extracting document context for the document, the document context comprising at least one of a document title, a document description, a document version, a document author, a document type, a link to the document, and a disclaimer associated with the document.

4. The apparatus of claim 1, wherein an iteration of the obtaining, determining, identifying, and extracting steps is performed for each of the two or more levels in the nested hierarchical structure, and wherein the identifying step in each of the iterations further comprises identifying one or more parent-child relationships for items in the given level of the nested hierarchical structure of the text data with one or more other items in one or more other ones of the two or more levels in the nested hierarchical structure.

5. The apparatus of claim 4 wherein a first one of the iterations of the obtaining, determining, identifying and extracting steps is performed for a topmost one of the two or more levels in the nested hierarchical structure and wherein subsequent ones of the iterations of the obtaining, determining, identifying and extracting steps are performed for lower ones of the two or more levels in the nested hierarchical structure.

6. The apparatus of claim 1 wherein the at least one sample item is obtained from a document hierarchy template associated with the document.

7. The apparatus of claim 1 wherein determining the list type associated with the at least one sample item comprises analyzing a syntax of the at least one sample item to infer the determined list type.

8. The apparatus of claim 1 wherein determining the list type associated with the at least one sample item comprises matching the at least one sample item with a set of known list types.

9. The apparatus of claim 8 wherein when the at least one sample item matches two or more of the set of known list types, determining the list type associated with the at least one sample item comprises selecting a most specific one of the matched two or more known list types.

10. The apparatus of claim 9 wherein the set of known list types are arranged in a list type hierarchy from least specific to most specific, and wherein selecting the most specific one of the matched two or more known list types comprises traversing the list type hierarchy until the most specific one of the matched two or more known list types is reached.

11. The apparatus of claim 8 wherein when the at least one sample item does not exactly match a syntax of any of the set of known list types, determining the list type associated with the at least one sample item comprises selecting from the set of known list types a longest matching one of the known list types that matches a portion of text of the at least one sample item.

12. The apparatus of claim 8 wherein when the at least one sample item does not exactly match a syntax of any of the set of known list types, determining the list type associated with the at least one sample item comprises performing approximate matching of text of the at least one sample item with at least one of the known list types in the set of known list types.

13. The apparatus of claim 1 wherein the at least one sample item comprises a first sample item with a first syntax and a second sample item with a second syntax different than the first syntax, wherein determining the list type associated with the at least one sample item comprises determining a first list type associated with the first sample item and a second list type associated with the second sample item, and wherein identifying items having the determined list type comprise identifying one or more items having the first list type and identifying one or more items having the second list type.

14. The apparatus of claim 1 wherein the structured version of the document comprises a structured file format comprising a list of the identified items each comprising at least one key specifying a unique identifier for a given one of the identified items and parent-child relationships of the given identified item with one or more other items in one or more other ones of the two or more levels in the nested hierarchical structure, the structured file format comprising one of an Extensible Markup Language (XML) format and a JavaScript Object Notation (JSON) format.

15. The apparatus of claim 1 wherein the structured version of the document comprises a Comma Separated Value (CSV) file for each of the two or more levels in the nested hierarchical structure, a given one of the CSV files for the given level of the nested hierarchical structure comprising at least one column specifying parent-child relationships of a given one of the identified items with one or more other items in one or more other ones of the two or more levels in the nested hierarchical structure.

16. The apparatus of claim 1 wherein the document comprises a regulatory document specifying one or more requirements for operation of assets in an information technology (IT) infrastructure, and wherein the at least one processing device is further configured to perform the step of utilizing the structured version of the document to map the specified one or more requirements to controls for operating the assets in the IT infrastructure.

17. A computer program product comprising a non-transitory processor-readable storage medium having stored therein program code of one or more software programs, wherein the program code when executed by at least one processing device causes the at least one processing device to perform steps of:
analyzing an unstructured version of a document to read text data contained therein, the text data having a nested hierarchical structure comprising two or more levels;
obtaining, for a given one of the two or more levels in the nested hierarchical structure, at least one sample item;
determining a list type associated with the at least one sample item;
identifying items having the determined list type in the text data of the document as belonging to the given level in the nested hierarchical structure;
extracting, from the document, portions of the text data corresponding to respective ones of the two or more items having the determined list type; and
generating a structured version of the document that associates the extracted portions of the text data with the corresponding ones of the two or more items having the determined list type.

18. The computer program product of claim 17 wherein the document comprises a regulatory document specifying one or more requirements for operation of assets in an information technology (IT) infrastructure, and wherein the program code when executed further causes the at least one processing device to perform the step of utilizing the structured version of the document to map the specified one or more requirements to controls for operating the assets in the IT infrastructure.

19. A method comprising:
analyzing an unstructured version of a document to read text data contained therein, the text data having a nested hierarchical structure comprising two or more levels;
obtaining, for a given one of the two or more levels in the nested hierarchical structure, at least one sample item;
determining a list type associated with the at least one sample item;
identifying items having the determined list type in the text data of the document as belonging to the given level in the nested hierarchical structure;
extracting, from the document, portions of the text data corresponding to respective ones of the two or more items having the determined list type; and
generating a structured version of the document that associates the extracted portions of the text data with the corresponding ones of the two or more items having the determined list type;
wherein the method is performed by at least one processing device comprising a processor coupled to a memory.

20. The method of claim 19 wherein the document comprises a regulatory document specifying one or more requirements for operation of assets in an information technology (IT) infrastructure, and further comprising utilizing the structured version of the document to map the specified one or more requirements to controls for operating the assets in the IT infrastructure.
